(19) United States
(12) Patent Application Publication
(10) Pub. No.: US 2024/0334286 A1
(43) Pub. Date: Oct. 3, 2024

(54) PER SUBSCRIBER INTER PLMN HANDOVER RESTRICTION IN 5G NETWORKS

(71) Applicant: Cisco Technology, Inc., San Jose, CA (US)

(72) Inventor: Jis Abraham, Bangalore (IN)

(21) Appl. No.: 18/193,104

(22) Filed: Mar. 30, 2023

(51) Int. Cl. H04W 36/18; H04W 36/00; H04W 36/14

(52) U.S. Cl. CPC H04W 36/18; H04W 36/0033; H04W 36/14; H04W 84/042

(57) ABSTRACT

A method comprises: at source network functions of a source public land mobile network (PLMN) (source PLMN): executing an attach procedure by which user equipment attaches to the source PLMN and establishes a data session with a data network; upon detecting a roam of the user equipment from the source PLMN to a target PLMN, accessing an inter-PLMN handover indicator that indicates whether a seamless inter-PLMN handover is allowed or is not allowed for the data network; and selectively performing the seamless inter-PLMN handover of the data session from the source PLMN to the target PLMN as directed by the inter-PLMN handover indicator.

### TECHNICAL FIELD

The present disclosure relates generally to network processing for call handovers across multiple networks.

### BACKGROUND

Differentiation between a seamless inter-public land mobile network (PLMN) call handover and a non-seamless inter-PLMN handover based on configuration parameters in 3rd Generation Partnership Project (3GPP) network functions is not currently available to operators. This hampers differential handling and billing as applied to those handovers.

### BRIEF DESCRIPTION OF THE DRAWINGS

FIG. 1 is a block diagram of a network environment in which embodiments directed to selectively performing a seamless inter-PLMN handover of a data session for user equipment (UE) from a home PLMN to a visited PLMN may be implemented, according to an example embodiment.

FIG. 2 shows data paths from the UE to a data network over the visited PLMN and the home PLMN before and after a handover of a data session for the UE from the visited PLMN to the home PLMN, according to an example embodiment.

FIGS. 3A and 3B are illustrations of a call flow for an inter-PLMN handover of a data session for the UE from the home PLMN to the visited PLMN, according to an example embodiment.

FIGS. 4A and 4B are illustrations of a call flow for an inter-PLMN handover of a data session for the UE from the visited PLMN to the home PLMN, according to an example embodiment.

FIG. 5 is a flowchart of a method of selectively performing a seamless inter-PLMN handover of a data session for the UE from a source PLMN to a target PLMN based on an inter-PLMN handover indictor, according to an example embodiment.

FIG. 6 is an illustration of a portion of a user subscription database that includes an inter-PLMN handover indicator per data network name (DNN) for a subscriber of the home PLMN, according to an embodiment.

FIG. 7 illustrates a hardware block diagram of a computing device that may perform functions associated with operations discussed herein, according to an example embodiment.

### DETAILED DESCRIPTION

### Overview

In an embodiment, a method is performed by source network functions of a source public land mobile network (PLMN). The method includes: executing an attach procedure by which user equipment attaches to the source PLMN and establishes a data session with a data network; upon detecting a roam of the user equipment from the source PLMN to a target PLMN, accessing an inter-PLMN handover indicator that indicates whether a seamless inter-PLMN handover is allowed or is not allowed for the data network; and selectively performing the seamless inter-PLMN handover of the data session from the source PLMN to the target PLMN as directed by the inter-PLMN handover indicator.

### Example Embodiments

The ensuing description refers to the following acronyms:
AMF—access and mobility management function.
DN—data network.
DNN—data network name.
NAS—non-access stratum.
PLMN—public land mobile network.
RAN—radio access network.
RAT—radio access technology.
SMF—session management function.
UE—user equipment.
UDF—unified data management (function).
UPF—user plane function.
NAS—non-access stratum.

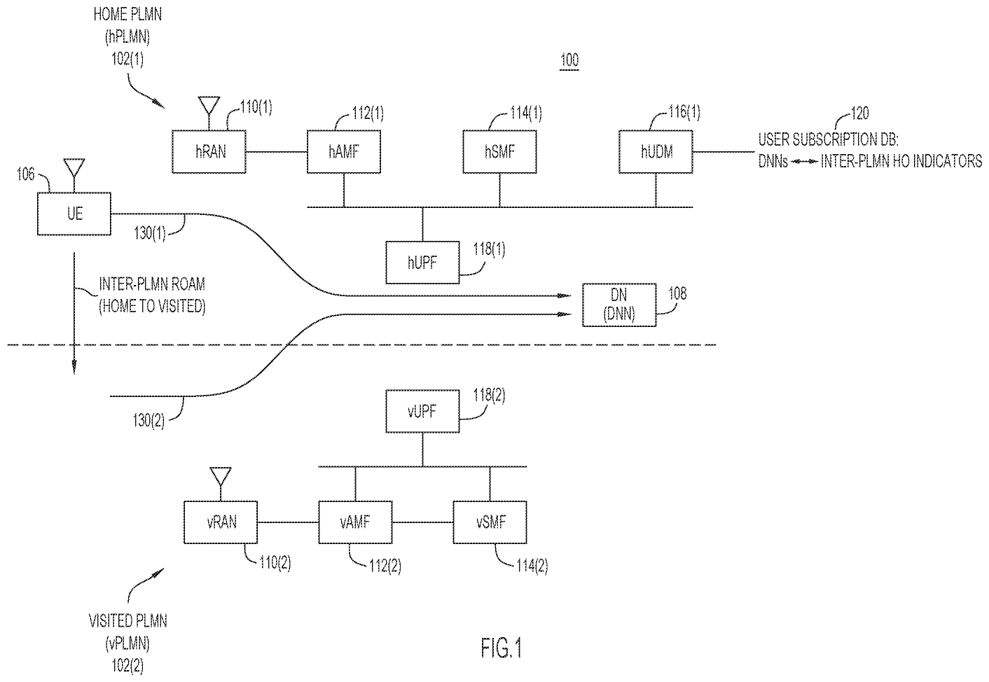

FIG. 1 is a block diagram of an example network environment 100 in which embodiments directed to selectively performing a seamless inter-PLMN handover of a data session of a UE may be implemented. As used herein, a PLMN may include one or more networks that provide a combination of wireless communication services including cellular services offered by a specific operator in a specific geographical region or coverage area. A PLMN is identified by a unique PLMN code, sometimes referred to as a PLMN identifier (PLMN-ID). Network environment 100 includes a home PLMN 102(1), a visitor or visited PLMN 102(2), UE 106, and a data network (DN) 106. In other examples, network environment 100 may include more PLMNs, more UEs, and more DNs. Home PLMN 102(1) (also referred to as the “hPLMN”) is the PLMN on which UE 106 and a user associated with UE 106 are defined/identified as subscribers in user subscription database. On the other hand, visited PLMN 102(2) (also referred to as the “vPLMN”) is operated by a roaming partner with which an operator of home PLMN 102(1) has a roaming agreement. Visited PLMN 102(2) may also be referred to as a “partner” PLMN. Home PLMN 102(1) and visited PLMN 102(2) may be referred to collectively as “PLMNs 102.”

In the example of FIG. 1, home PLMN 102(1) and visited PLMN 102(2) are Third Generation Partnership Project (3GPP) Fifth Generation (5G) mobile networks. PLMNs 102 include 5G mobile network functions (also referred to as “core” network functions) coupled to, and which communicate with, each other over 3GPP signaling interfaces. The “home” network functions of home PLMN 102(1) include a RAN 110(1), an AMF 112(1), an SMF 114(1), a UDM 116(1), and a UPF 118(1), which may also be referred to as an hRAN, an hAMF, an hSMF, an hUDM, and an hUPF, respectively, where “h” designates “home.” UDM 116(1) is configured with a user subscription database (DB) 120 that includes subscription information pertaining to the user and UE 106 including, but not limited to, subscriber plans, user and UE identifiers (IDs), roaming permissions, and a list of DNNs to which UE 106 can connect. According to embodiments presented herein, user subscription database 120 further includes a new subscription parameter that is configured per subscriber and per DNN, referred to as an “inter-PLMN handover (HO) indicator” (also referred to as an “inter-PLMN HO allowed indicator”), described below.

Similar to home PLMN 102(1), visited PLMN 102(2) includes “visited” network functions of 5G coupled to, and which communicate with, each other over 3GPP signaling interfaces. The network functions of visited PLMN 102(2) include a RAN 110(2), an AMF 112(2), an SMF 114(2), and a UPF 118(2), which may also be referred to as a vRAN, a vAMF, a vSMF, and a vUPF, respectively, where “v” designates “visited.” In an example, the home network functions of home PLMN 102(1) and the visited network functions of visited PLMN 102(2) may comprises executable applications hosted on one or more computing devices, such as servers or the like, that include one or more processors to execute control logic of the applications to perform the operations described herein.

UE 106 accesses DN 108 through PLMNs 102. To that end, UE 106 can initially attach to, and establish a PDU session with, DN 108 over a first PLMN (e.g., hPLMN) of PLMNs 102, referred to as the “source” PLMN. Then, UE 106 can roam from the source PLMN to a second PLMN (e.g., vPLMN) of PLMNs 102, referred to as the “target” PLMN. The roam is movement of UE 106 from a location in a source coverage area of the source PLMN (e.g., a source coverage area of the RAN associated with the source PLMN) to a location that is outside of (or nearly outside of) the source coverage area, and that is in a target coverage area of the target PLMN (e.g., a target coverage area of the RAN associated with the target PLMN). According to the embodiments presented herein, the roam triggers the source PLMN to perform an inter-PLMN handover of the PDU session from the source PLMN to the target PLMN based on the inter-PLMN HO indictor for DN 108 (which is stored in user subscription database 120). More specifically, PLMNs 102 selectively perform a seamless inter-PLMN handover or a non-seamless inter-PLMN handover of the PDU session from the source PLMN to the target PLMN, as directed by the inter-PLMN HO indicator.

For the handover, when the inter-PLMN HO indicator indicates that a seamless inter-PLMN handover is allowed for the PDU session (on DN 108), the respective network functions of PLMNs 102 interact/cooperate with each other to perform the seamless inter-PLMN handover of the PDU session from the source PLMN to the target PLMN. The seamless inter-PLMN handover maintains uninterrupted PDU session continuity across the roam/handover, maintains the same PDU session identifier (ID), and is transparent to UE 106 because there is no interruption of the PDU session or service (e.g., voice or data service) supported by the PDU session.

On the other hand, when the inter-PLMN handover indicator indicates that the seamless inter-PLMN handover is not allowed, PLMNs 102 do not interact with each other to perform the seamless inter-PLMN handover. Instead, the existing PDU session is torn down, and a new PDU session is established between UE 106 and DN 108 over the target PLMN. The foregoing actions interrupt the existing PDU session. Moreover, the handover is not transparent to UE 106. The differential treatment of the inter-PLMN handover directed by the inter-PLMN HO indicator advantageously allows for differential billing of the subscriber for the handover.

FIG. 1 shows a data path 130(1) (i.e., a user traffic path) and a data path 130(2) from UE 106 to DN 108 through respective network functions of PLMNs 102 before and after a handover from home PLMN 102(1) (i.e., the hPLMN) to visited PLMN 102(2) (i.e., the vPLMN), respectively. In this case, the hPLMN=the source (S) PLMN (S-PLMN), and the vPLMN=the target (T) PLMN (T-PLMN). Before the handover, when UE 106 has established the PDU session with DN 108 over home PLMN 102(1), data path 130(1) includes UE 106, RAN 110(1), UPF 118(1), and DN 108. After the roam of UE 106 that results in the handover, data path 130(2) includes UE 106, RAN 110(2), UPF 118(2), UPF 118(1), and DN 108. Data path 130(2) includes a tunnel from UPF 118(2) to UPF 118(1) in data path 130(2), which is created transparently or seamlessly with respect to UE 106 in the case of the seamless inter-PLMN handover. That is, the tunnel is created without noticeable interruption of service to a user of UE 106.

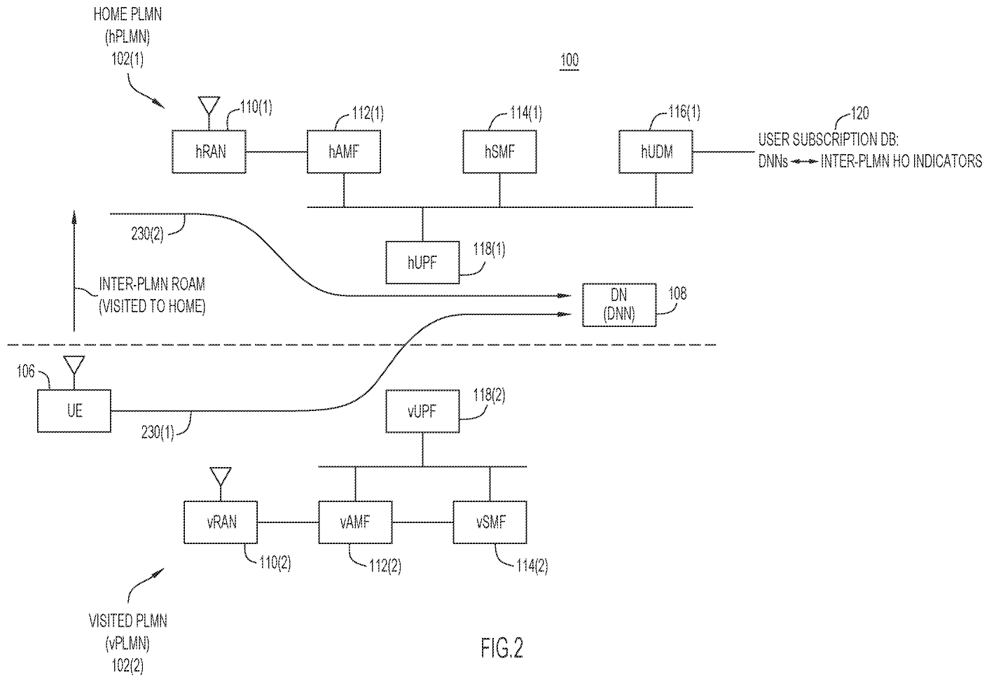

FIG. 2 shows a data path 230(1) and a data path 230(2) from UE 106 to DN 108 through PLMNs 102 before and after a handover from visited PLMN 102(2) (i.e., the vPLMN) to home PLMN 102(1) (i.e., the hPLMN), respectively. Before the handover, when UE 106 has established the PDU session with DN 108 over visited PLMN 102(2), data path 230(1) includes UE 106, RAN 110(2), UPF 118(2), UPF 118(1), and DN 108. Data path 230(1) includes a tunnel from UPF 118(2) to UPF 118(1). After the roam that results in the handover, data path 230(2) includes UE 106, RAN 110(1), UPF 118(1), and DN 108.

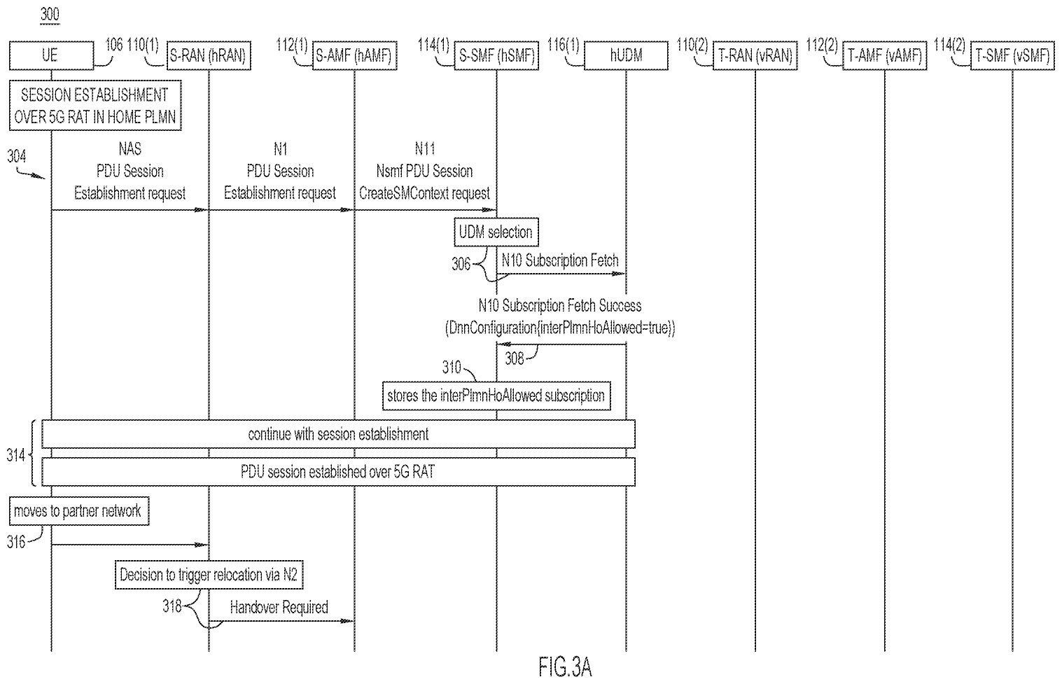

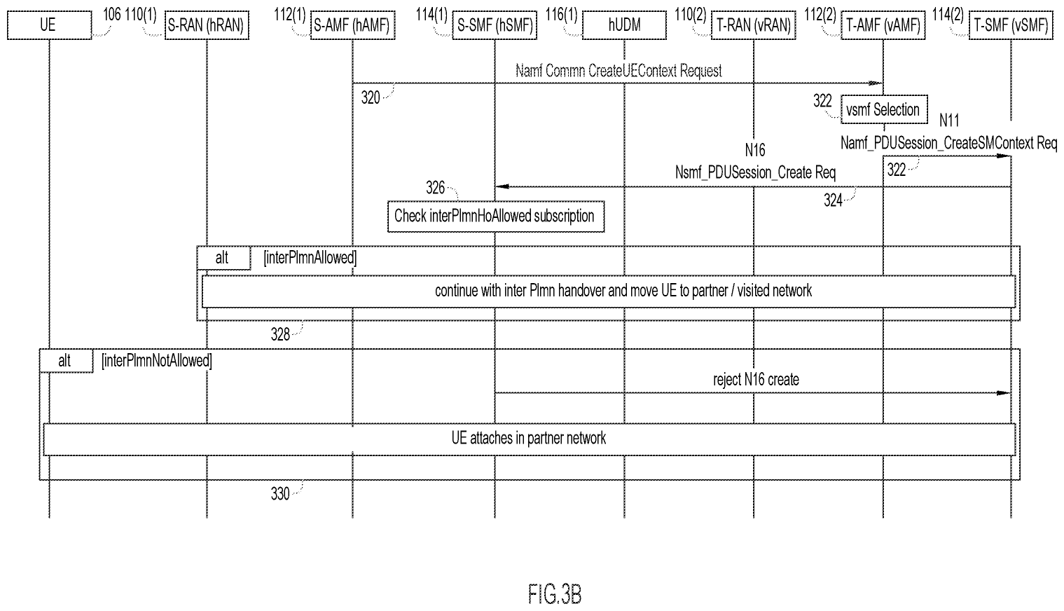

FIGS. 3A and 3B are illustrations of an example call flow 300 for an inter-PLMN handover of a PDU session for UE 106 from home PLMN 102(1) (i.e., the hPLMN) to visited PLMN 102(2) (i.e., the vPLMN). In this case, hPLMN=S-PLMN and vPLMN=T-PLMN. The terms “source” and “home” are synonymous and both refer to home PLMN 102(1) (i.e., the hPLMN). Similarly, the terms “target” and “visited” are synonymous and both refer to visited PLMN 102(2) (i.e., the vPLMN). Call flow 300 is described first with reference to FIG. 3A and also with continued reference to FIG. 1.

Initially. UE 106 attaches to the hPLMN (i.e., the S-PLMN) and establishes a PDU session with DN 108 over the home access RAT (which includes the hRAN) of the hPLMN. The foregoing attach/establish procedures are described in connection with next transactions 304 and 314. At 304, UE 106 sends to the S-RAN (i.e., the hRAN) an NAS PDU session establishment request. In response (i.e., upon receiving the request), the S-RAN forwards to the S-AMF (i.e., the hAMF) an N1 PDU session establishment request. In response, the S-AMF forwards to the S-SMF (i.e., the hSMF) an N11 PDU session create SMF context request. The request includes a subscriber ID, a PDU session ID, an indication that this is to establish a new PDU session, and a DNN of DN 108.

In response, at 306, the S-SMF (i.e., the hSMF) selects the hUDM and forwards to the hUDM an N10 user subscription fetch/request, which includes the DNN of DN 108 (i.e., the fetch identifies DN 108). In response, at 308, the hUDM sends back to the S-SMF an N10 fetch response. The fetch response includes the inter-PLMN handover (HO) indictor for DN 108 that is stored in user subscription database 120. In this case, the inter-PLMN HO indicator indicates that the seamless inter-PLMN handover is allowed for DN 108; in FIG. 3A, this is denoted as “DnnConfiguration[InterPlmnHoAllowed=true].” At 310, the S-SMF (i.e., the hSMF) stores the inter-PLMN HO indicator locally for later access during a handover procedure triggered by a roam of UE 106, described below.

At 314, the network functions of the hPLMN (i.e., the S-PLMN) and UE 106 interact to continue with PDU establishment, which leads to establishment of the PDU session (with the PDU session ID) for the UE with DN 108 over the hPLMN. This establishes data path 130(1) (shown in FIG. 1) between UE 106 and DN 108.

At 316, UE 106 moves/roams to the vPLMN (i.e., the T-PLMN). At 318, the S-RAN (i.e., the hRAN) detects the roam, which triggers the S-RAN to send to the S-AMF (i.e., the hAMF) a message that indicates a handover event, i.e., that a handover is required. The S-RAN detects the roam using any known or hereafter developed technique, for example, using reports of transmit and receive radio frequency (RF) power measurements for UE 106. Referring now to FIG. 3B, in response, at 320, the S-AMF (i.e., the hAMF) sends to the T-AMF (i.e., the vAMF), an “Namf communication (Common) create UE context request” that indicates the handover event. In response, at 322, the T-AMF (i.e., the vAMF) selects the T-SMF (i.e., the vSMF) and forwards an “Nsmf PDU session SM context request” message to the T-SMF.

In response, at 324, the T-SMF (i.e., the vSMF) sends to the S-SMF (i.e., the hSMF) an N16 “Nsmf PDU session create request” message that includes the subscriber ID, the PDU session ID, a handover indication, and the DNN of DN 108.

In response, at 326, the S-SMF (i.e., the hSMF) accesses and interprets the previously stored inter-PLMN HO indicator for DN 108 based on the DNN in the request from 324. The S-SMF (i.e., the hSMF) determines whether seamless inter-PLMN handover is allowed or is not allowed based on the indicator (e.g., whether the indicator is true=allowed, or false=not allowed).

When the inter-PLMN HO indicator indicates that the seamless inter-PLMN handover is allowed, at 328, the respective network functions of the hPLMN (i.e., the S-PLMN) and the vPLMN (i.e., the T-PLMN) interact with each other to perform the seamless inter-PLMN handover of the PDU session from the hPLMN to the vPLMN. This establishes data path 130(2) (shown in FIG. 1) between UE 106 and DN 108.

On the other hand, when the inter-PLMN HO indicator indicates that the seamless inter-PLMN handover is not allowed, the seamless inter-PLMN handover is not performed. Instead, at 330, the PDU session is torn down or cleared. This forces UE 106 to execute new attach and PDU establishment procedures with the vPLMN (i.e., the T-PLMN) to establish a new PDU session (with a new PDU session ID) with DN 108, over the vPLMN. In this case, the S-SMF (i.e., the hSMF) sends to the T-SMF (i.e., the vSMF) a reject N16 create, which rejects the “N16 Nsmf PDU session create request” sent by the T-SMF to the S-SMF previously at 324.

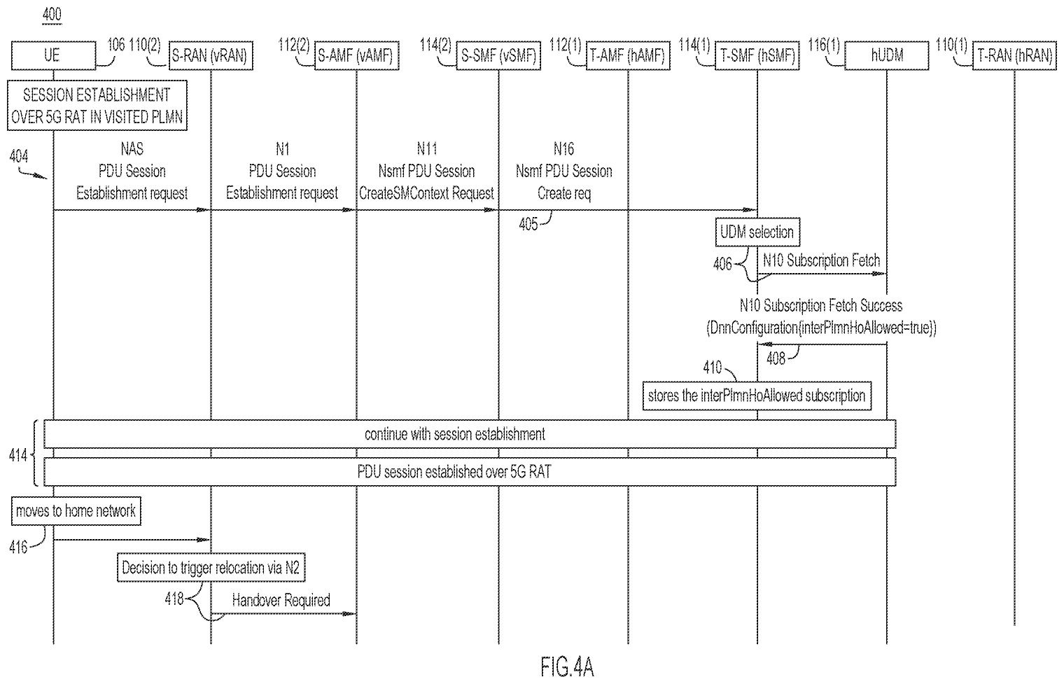

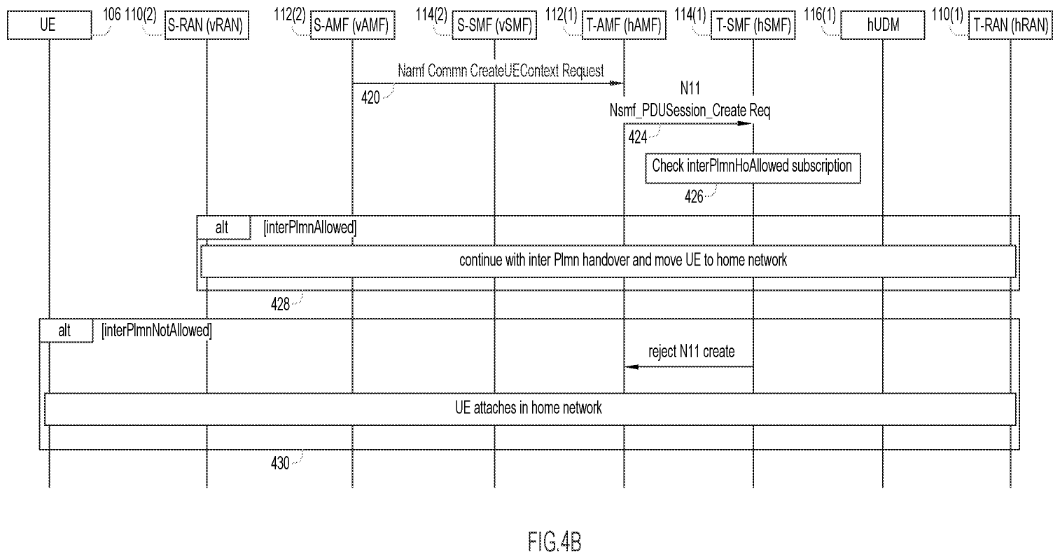

FIGS. 4A and 4B are illustrations of an example call flow 400 for an inter-PLMN handover of a PDU session for UE 106 from the vPLMN to the hPLMN. In this case, vPLMN=S-PLMN and hPLMN=T-PLMN. The terms “source” and “visited” are synonymous and both refer to visited PLMN 102(2). Similarly, the terms “target” and “home” are synonymous and refer to home PLMN 102(1). Call flow 400 is described first with reference to FIG. 4B and also with continued reference to FIG. 2.

Initially, UE 106 attaches to the vPLMN (i.e., the S-PLMN) and establishes a PDU session with DN 108 over the visited access RAT (which includes the vRAN) of the vPLMN. The foregoing attach/establish procedures are described in connection with next transactions 404 and 414. At 404, UE 106 sends to the S-RAN (i.e., the vRAN) an NAS PDU session establishment request. In response, the S-RAN (i.e., the vRAN) forwards to the S-AMF (i.e., the vAMF) an N1 PDU session establishment request. In response, the S-AMF (i.e., the vAMF) forwards to the S-SMF (i.e., the vSMF) an N11 PDU session create SM context request. In response, because the S-SMF (i.e., the vSMF) is not the hSMF in this case, at 405, the S-SMF sends to the T-SMF (i.e., the hSMF), an N16 PDU session create request.

In response, at 406, the T-SMF (i.e., the hSMF) selects the hUDM and forwards to the hUDM an N10 user subscription fetch/request, which includes a DNN of DN 108 (i.e., the fetch identifies the DN). In response, at 408, the hUDM sends back to the T-SMF (i.e., the hSMF) an N10 fetch response. The fetch response includes the inter-PLMN HO indictor for DN 108 that is stored in user subscription database 120. In the example, the inter-PLMN HO indicator indicates that seamless inter-PLMN handover is allowed for DN 108. At 410, the hUDM stores the inter-PLMN HO indicator locally for later access when needed for a handover procedure.

At 414, the network functions of the vPLMN (i.e., the S-PLMN) and UE 106 interact to continue with PDU establishment, which leads to establishment of the PDU session for the UE with DN 108 over the vPLMN. This establishes data path 230(1) between UE 106 and DN 108, as shown in FIG. 2.

At 416, UE 106 moves/roams to the hPLMN (i.e., the T-PLMN). At 418, the S-RAN (i.e., the vRAN) detects the roam, which triggers the S-RAN to send to the S-AMF (i.e., the vAMF) a message that indicates a handover event. Referring to FIG. 4B, in response, at 420, the S-AMF (i.e., the vAMF) sends to the T-AMF (i.e., the hAMF), an “Namf common create UE context request” that indicates the handover event.

In response, at 424, the T-AMF (i.e., the hAMF) sends to the T-SMF (i.e., the hSMF) an N11 “Nsmf PDU session create request” that includes the subscriber ID, the PDU session ID, a handover indication, and the DNN of DN 108. In response, at 426, the T-SMF (i.e., the hSMF) accesses and interprets the previously stored inter-PLMN HO indicator for DN 108. The T-SMF (i.e., the hSMF) determines whether seamless inter-PLMN handover is allowed or is not allowed based on the indicator (e.g., whether the indicator is true=allowed, or false=not allowed).

When the inter-PLMN HO indicator indicates that the seamless inter-PLMN handover is allowed, at 428, the network functions of the vPLMN (i.e., the S-PLMN) interact with the network functions of the hPLMN (i.e., the T-PLMN) to perform the seamless inter-PLMN handover of the PDU session from the vPLMN to the hPLMN. This establishes data path 230(2) between UE 106 and DN 108, as shown in FIG. 2.

On the other hand, when the inter-PLMN HO indicator indicates that the seamless inter-PLMN handover is not allowed, the seamless inter-PLMN handover is not performed. Instead, at 430, the PDU session is torn down or cleared. This forces UE 106 to executed new attach and PDU establishment procedures with the hPLMN (i.e., the T-PLMN) to establish a new PDU session (and a new PDU session ID) with DN 108 over the hPLMN. In this case, the T-SMF (i.e., the hSMF) sends to the T-AMF (i.e., the vAMF) a reject N11 create, which rejects the “N11 Nsmf PDU session create request” sent by the T-AMF (i.e., the hAMF) to the T-SMF (i.e., the hSMF) previously at 424.

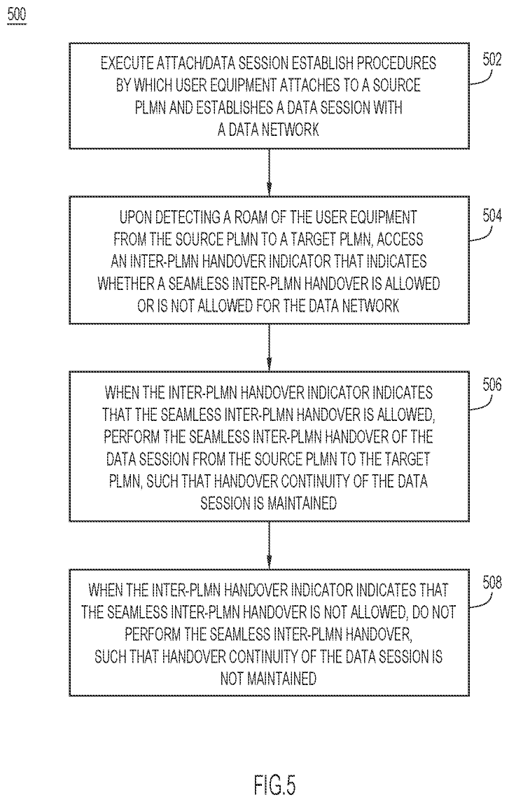

FIG. 5 is a flowchart of an example method 500 of selectively performing a seamless inter-PLMN handover of a data session for a UE from a source PLMN to a target PLMN based on an inter-PLMN HO indictor in a subscription database. Method 500 may be performed by source network functions of the source PLMN and target network functions of the target PLMN. The source PLMN and the target PLMN may operate in accordance with the 3GPP/5G standards modified or extended to implement the embodiments presented herein. The operations of method 500 described below are described above in connection with FIGS. 1-4B.

At 502, the source network functions of the source PLMN execute attach and session establish procedures by which the UE attaches to the source PLMN and establishes a data session (e.g., a PDU session) with a data network over the source PLMN. Upon executing the aforementioned procedures, the source network functions (i) fetch an inter-PLMN handover indicator for the data network from a user subscription database based on a data network name of the data network obtained from the attach/session establish procedures, and (ii) store the inter-PLMN handover indicator for later access. The inter-PLMN handover indicator is set to a value (e.g., true=1, or false=0), which indicates whether a seamless inter-PLMN handover is allowed or is not allowed for the data network.

Upon detecting a roam (i.e., movement by the UE that causes a relocation) of the UE from the source PLMN to the target PLMN, at 504, the source network functions of the source PLMN exchange inter-PLMN handover messages with the target network functions of the target PLMN, which triggers the source network functions to access the previously stored inter-PLMN handover indicator. The inter-PLMN handover indicator is evaluated to determine whether the seamless inter-PLMN handover is allowed or is not allowed for the data network.

In a case where the source PLMN is a home PLMN of the UE and the target PLMN is a visited PLMN, the exchange of inter-PLMN handover messages includes in part:
a. Sending, from the home PLMN to the visited PLMN, a create UE context request that indicates a handover event for the data session (e.g., FIG. 3B, 320).
b. In response to sending, receiving (at the home PLMN) from the visited PLMN, a data session create request that indicates the handover event for the data session (e.g., FIG. 3B, 324).

On the other hand, in a case where the source PLMN is the visited PLMN and the target PLMN is the home PLMN, the exchange of inter-PLMN handover messages includes in part:
a. Sending, from the visited PLMN to the home PLMN, a create UE context request that identifies a handover event for the data session (e.g., FIG. 4B, 420).

When the inter-PLMN handover indicator indicates that the seamless inter-PLMN handover is allowed, at 506, the source network functions of the source PLMN interact/cooperate with the target network functions of the target PLMN (e.g., exchange further inter-PLMN handover messages) to perform the seamless inter-PLMN handover of the data session from the source PLMN to the target PLMN, such that handover continuity of the data session is maintained across the roam. That is, the seamless inter-PLMN handover maintains uninterrupted PDU session continuity across (and after) the roam/handover, maintains the same PDU session identifier (ID), and is transparent to UE 106 because there is no interruption of the PDU session. That is, the PDU session persists across the source and target PLMNs throughout and then after the handover. From the perspective of the UE, the data session is not interrupted and is therefore seamless.

When the inter-PLMN handover indicator indicates that the seamless inter-PLMN handover is not allowed, at 508, the source network functions do not perform the seamless inter-PLMN handover, such that handover continuity of the data session across the PLMNs is not maintained. Instead, the existing PDU session is torn down, and a new PDU session is established between UE 106 and DN 108 over the target PLMN. The foregoing actions interrupt the existing PDU session. Moreover, the handover is not transparent to UE 106.

Operations 506 and 508 collectively represent cooperation or interaction between the source network functions and the target network functions to selectively perform the seamless inter-PLMN handover or not perform the seamless inter PLMN handover (i.e., perform a non-seamless inter-PLMN handover) of the data session from the source PLMN to the target PLMN, as directed by the inter-PLMN handover indicator.

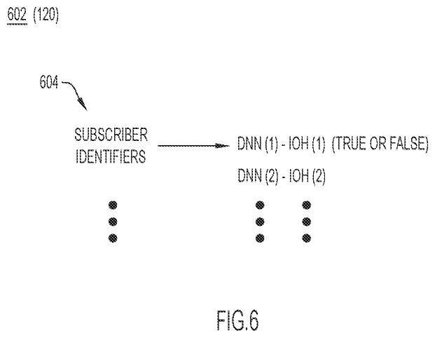

FIG. 6 is an illustration of a portion of user subscription database 120 modified to include the inter-PLMN HO indictor (also referred to as a “subscription parameter”) per DNN for a subscriber (i.e., per subscriber) to home PLMN 102(1). User subscription database 120 includes a subscriber record 602 for a corresponding subscriber. User subscription database 120 generally will include multiple such subscriber records each for a corresponding one of multiple subscribers. Subscriber record 602 includes subscriber identifiers 604, which may include identifiers of a user and one or more UEs associated with the subscriber (e.g., an International Mobile Subscriber Identity (IMSI), a Subscription Permanent Identifier (SUPI), or the like). Subscriber record 602 includes DNNs DNN(1), DNN(2) that are mapped to corresponding ones of inter-PLMN HO indictors (HOIs) HOI(1), HOI(2), and so on. Each HOI indictor is set=true or set=false, for example. True indicates that seamless inter-PLMN handover is allowed for the corresponding DNN, while false indicates that seamless inter-PLMN handover is not allowed for the corresponding DNN, for example.

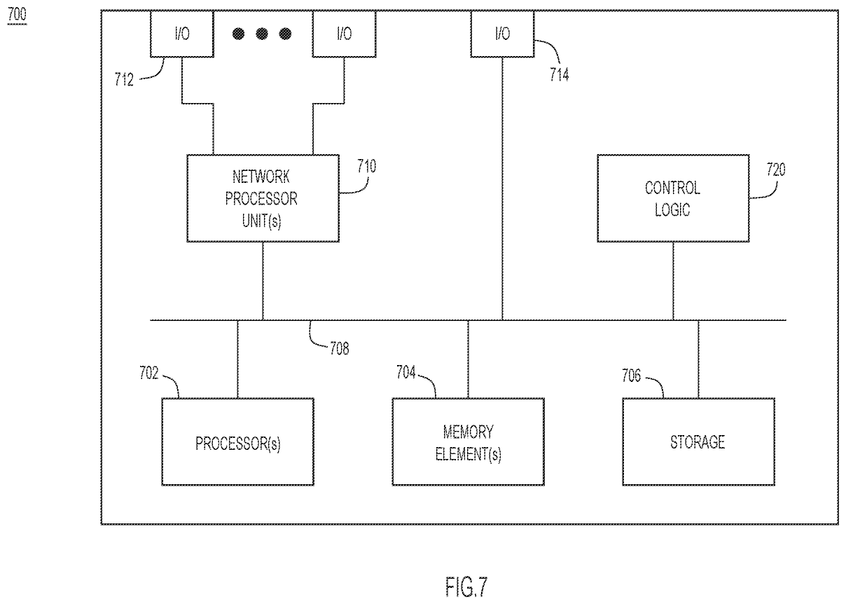

Referring to FIG. 7, FIG. 7 illustrates a hardware block diagram of a computing device 700 that may perform functions associated with operations discussed herein in connection with the techniques depicted in FIGS. 1-6. In various embodiments, a computing device or apparatus, such as computing device 700 or any combination of computing devices 700, may be configured as any entity/entities as discussed for the techniques depicted in connection with FIGS. 1-6 in order to perform operations of the various techniques discussed herein. For example, computing device 700 may implement each of the network functions of home PLMN 102(1) and each of the network functions of PLMN 102(2). For example, each network function 110(i), 112(i), 114(i), 116(i), and 118(i) may be implemented in computing device 700. Computing device 700 may also implement UE 106.

In at least one embodiment, the computing device 700 may be any apparatus that may include one or more processor(s) 702, one or more memory element(s) 704, storage 706, a bus 708, one or more network processor unit(s) 710 interconnected with one or more network input/output (I/O) interface(s) 712, one or more I/O interface(s) 714, and control logic 720. In various embodiments, instructions associated with logic for computing device 700 can overlap in any manner and are not limited to the specific allocation of instructions and/or operations described herein.

In at least one embodiment, processor(s) 702 is/are at least one hardware processor configured to execute various tasks, operations and/or functions for computing device 700 as described herein according to software and/or instructions configured for computing device 700. Processor(s) 702 (e.g., a hardware processor) can execute any type of instructions associated with data to achieve the operations detailed herein. In one example, processor(s) 702 can transform an element or an article (e.g., data, information) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 704 and/or storage 706 is/are configured to store data, information, software, and/or instructions associated with computing device 700, and/or logic configured for memory element(s) 704 and/or storage 706. For example, any logic described herein (e.g., control logic 720) can, in various embodiments, be stored for computing device 700 using any combination of memory element(s) 704 and/or storage 706. Note that in some embodiments, storage 706 can be consolidated with memory element(s) 704 (or vice versa), or can overlap/exist in any other suitable manner.

In at least one embodiment, bus 708 can be configured as an interface that enables one or more elements of computing device 700 to communicate in order to exchange information and/or data. Bus 708 can be implemented with any architecture designed for passing control, data and/or information between processors, memory elements/storage, peripheral devices, and/or any other hardware and/or software components that may be configured for computing device 700. In at least one embodiment, bus 708 may be implemented as a fast kernel-hosted interconnect, potentially using shared memory between processes (e.g., logic), which can enable efficient communication paths between the processes.

In various embodiments, network processor unit(s) 710 may enable communication between computing device 700 and other systems, entities, etc., via network I/O interface(s) 712 (wired and/or wireless) to facilitate operations discussed for various embodiments described herein. In various embodiments, network processor unit(s) 710 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 700 and other systems, entities, etc. to facilitate operations for various embodiments described herein. In various embodiments, network I/O interface(s) 712 can be configured as one or more Ethernet port(s), Fibre Channel ports, any other I/O port(s), and/or antenna(s)/antenna array(s) now known or hereafter developed. Thus, the network processor unit(s) 710 and/or network I/O interface(s) 712 may include suitable interfaces for receiving, transmitting, and/or otherwise communicating data and/or information in a network environment.

I/O interface(s) 714 allow for input and output of data and/or information with other entities that may be connected to computing device 700. For example, I/O interface(s) 714 may provide a connection to external devices such as a keyboard, keypad, a touch screen, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 720 can include instructions that, when executed, cause processor(s) 702 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof; and/or the like to facilitate various operations for embodiments described herein.

The programs described herein (e.g., control logic 720) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, any entity or apparatus as described herein may store data/information in any suitable volatile and/or non-volatile memory item (e.g., magnetic hard disk drive, solid state hard drive, semiconductor storage device, random access memory (RAM), read only memory (ROM), crasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 704 and/or storage 706 can store data, software, code, instructions (e.g., processor instructions), logic, parameters, combinations thereof, and/or the like used for operations described herein. This includes memory element(s) 704 and/or storage 706 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

### Variations and Implementations

Embodiments described herein may include one or more networks, which can represent a series of points and/or network elements of interconnected communication paths for receiving and/or transmitting messages (e.g., packets of information) that propagate through the one or more networks. These network elements offer communicative interfaces that facilitate communications between the network elements. A network can include any number of hardware and/or software elements coupled to (and in communication with) each other through a communication medium. Such networks can include, but are not limited to, any local area network (LAN), virtual LAN (VLAN), wide area network (WAN) (e.g., the Internet), software defined WAN (SD-WAN), wireless local area (WLA) access network, wireless wide area (WWA) access network, metropolitan area network (MAN), Intranet, Extranet, virtual private network (VPN), Low Power Network (LPN), Low Power Wide Area Network (LPWAN), Machine to Machine (M2M) network, Internet of Things (IoT) network, Ethernet network/switching system, any other appropriate architecture and/or system that facilitates communications in a network environment, and/or any suitable combination thereof.

Networks through which communications propagate can use any suitable technologies for communications including wireless communications (e.g., 4G/5G/nG, IEEE 802.11 (e.g., Wi-Fi®/Wi-Fi6®), IEEE 802.16 (e.g., Worldwide Interoperability for Microwave Access (WiMAX)), Radio-Frequency Identification (RFID), Near Field Communication (NFC), Bluetooth™, mm.wave, Ultra-Wideband (UWB), etc.), and/or wired communications (e.g., T1 lines, T3 lines, digital subscriber lines (DSL), Ethernet, Fibre Channel, etc.). Generally, any suitable means of communications may be used such as electric, sound, light, infrared, and/or radio to facilitate communications through one or more networks in accordance with embodiments herein. Communications, interactions, operations, etc. as discussed for various embodiments described herein may be performed among entities that may directly or indirectly connected utilizing any algorithms, communication protocols, interfaces, etc. (proprietary and/or non-proprietary) that allow for the exchange of data and/or information.

In various example implementations, any entity or apparatus for various embodiments described herein can encompass network elements (which can include virtualized network elements, functions, etc.) such as, for example, network appliances, forwarders, routers, servers, switches, gateways, bridges, loadbalancers, firewalls, processors, modules, radio receivers/transmitters, or any other suitable device, component, element, or object operable to exchange information that facilitates or otherwise helps to facilitate various operations in a network environment as described for various embodiments herein. Note that with the examples provided herein, interaction may be described in terms of one, two, three, or four entities. However, this has been done for purposes of clarity, simplicity and example only. The examples provided should not limit the scope or inhibit the broad teachings of systems, networks, etc. described herein as potentially applied to a myriad of other architectures.

Communications in a network environment can be referred to herein as ‘messages’, ‘messaging’, ‘signaling’, ‘data’, ‘content’, ‘objects’, ‘requests’, ‘queries’, ‘responses’, ‘replies’, etc. which may be inclusive of packets. As referred to herein and in the claims, the term ‘packet’ may be used in a generic sense to include packets, frames, segments, datagrams, and/or any other generic units that may be used to transmit communications in a network environment. Generally, a packet is a formatted unit of data that can contain control or routing information (e.g., source and destination address, source and destination port, etc.) and data, which is also sometimes referred to as a ‘payload’, ‘data payload’, and variations thereof. In some embodiments, control or routing information, management information, or the like can be included in packet fields, such as within header(s) and/or trailer(s) of packets. Internet Protocol (IP) addresses discussed herein and in the claims can include any IP version 4 (IPv4) and/or IP version 6 (IPv6) addresses.

To the extent that embodiments presented herein relate to the storage of data, the embodiments may employ any number of any conventional or other databases, data stores or storage structures (e.g., files, databases, data structures, data or other repositories, etc.) to store information.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Each example embodiment disclosed herein has been included to present one or more different features. However, all disclosed example embodiments are designed to work together as part of a single larger system or method. This disclosure explicitly envisions compound embodiments that combine multiple previously-discussed features in different example embodiments into a single system or method.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of can be represented using the’(s)′ nomenclature (e.g., one or more element(s)).

In summary, in some aspects, the techniques described herein relate to a method including: at source network functions of a source public land mobile network (PLMN) (source PLMN): executing an attach procedure by which user equipment attaches to the source PLMN and establishes a data session with a data network; upon detecting a roam of the user equipment from the source PLMN to a target PLMN, accessing an inter-PLMN handover indicator that indicates whether a seamless inter-PLMN handover is allowed or is not allowed for the data network; and selectively performing the seamless inter-PLMN handover of the data session from the source PLMN to the target PLMN as directed by the inter-PLMN handover indicator.

In some aspects, the techniques described herein relate to a method, wherein selectively performing includes: when the inter-PLMN handover indicator indicates that the seamless inter-PLMN handover is allowed, performing the seamless inter-PLMN handover of the data session from the source PLMN to the target PLMN, such that handover continuity of the data session is maintained.

In some aspects, the techniques described herein relate to a method, wherein selectively performing further includes: when the inter-PLMN handover indicator indicates that the seamless inter-PLMN handover is not allowed, not performing the seamless inter-PLMN handover of the data session from the source PLMN to the target PLMN, such that handover continuity of the data session is not maintained.

In some aspects, the techniques described herein relate to a method, wherein the inter-PLMN handover indicator is stored in a user subscription database that includes data network names mapped to inter-PLMN handover indicators that each indicates whether a seamless inter-PLMN handover is allowed or is not allowed, and the method further includes: upon executing the attach procedure, fetching the inter-PLMN handover indicator from the user subscription database based on a data network name of the data network obtained from the attach procedure, and storing the inter-PLMN handover indicator for later access, wherein accessing includes accessing the inter-PLMN handover indicator as stored.

In some aspects, the techniques described herein relate to a method, further including, at the source network functions of the source PLMN: upon detecting the roam, exchanging inter-PLMN handover messages with target network functions of the target PLMN; and triggering accessing the inter-PLMN handover indicator responsive to exchanging the inter-PLMN handover messages.

In some aspects, the techniques described herein relate to a method, wherein the source PLMN is a home PLMN of a user associated with the user equipment, the target PLMN is a visited PLMN, and exchanging includes: sending, to the visited PLMN, a user equipment context request that indicates a handover event for the data session; and in responsive to sending, receiving, from the visited PLMN, a data session request that indicates a handover event for the data session.

In some aspects, the techniques described herein relate to a method, wherein the target PLMN is a home PLMN of a user associated with the user equipment, the source PLMN is a visited PLMN, and exchanging includes: sending, to the home PLMN, a user equipment context request that identifies a handover event for the data session.

In some aspects, the techniques described herein relate to a method, wherein: the source network functions include a source radio access network (RAN), a source session management function (SMF), and a source access and mobility management function (AMF).

In some aspects, the techniques described herein relate to a method, wherein the source PLMN and the target PLMN are each a 5G network.

In some aspects, the techniques described herein relate to an apparatus including: one or more network processor units to communicate over one or more networks; and one or more processors coupled to the one or more network processor units and configured to implement source network functions of a source public land mobile network (PLMN) (source PLMN), wherein the one or more processors are configured to: execute an attach procedure by which user equipment attaches to the source PLMN and establishes a data session with a data network; upon detecting a roam of the user equipment from the source PLMN to a target PLMN, accessing an inter-PLMN handover indicator that indicates whether a seamless inter-PLMN handover is allowed or is not allowed for the data network; and selectively perform the seamless inter-PLMN handover or not perform the seamless inter-PLMN handover of the data session from the source PLMN to the target PLMN as directed by the inter-PLMN handover indicator.

In some aspects, the techniques described herein relate to an apparatus, wherein the one or more processors are configured to selectively perform by: when the inter-PLMN handover indicator indicates that the seamless inter-PLMN handover is allowed, perform the seamless inter-PLMN handover of the data session from the source PLMN to the target PLMN, such that handover continuity of the data session is maintained.

In some aspects, the techniques described herein relate to an apparatus, wherein the one or more processors are further configured to selectively perform by: when the inter-PLMN handover indicator indicates that the seamless inter-PLMN handover is not allowed, not perform the seamless inter-PLMN handover of the data session from the source PLMN to the target PLMN, such that handover continuity of the data session is not maintained.

In some aspects, the techniques described herein relate to an apparatus, wherein the inter-PLMN handover indicator is stored in a user subscription database that includes data network names mapped to inter-PLMN handover indicators that each indicates whether a seamless inter-PLMN handover is allowed or is not allowed, and the one or more processors are further configured to: upon executing the attach procedure, fetch the inter-PLMN handover indicator from the user subscription database based on a data network name of the data network obtained from the attach procedure, and store the inter-PLMN handover indicator for later access, wherein the one or more processors are configured to access by accessing the inter-PLMN handover indicator as stored.

In some aspects, the techniques described herein relate to an apparatus, wherein the one or more processors are further configured to: upon detecting the roam, exchange inter-PLMN handover messages with target network functions of the target PLMN, and which trigger access of the inter-PLMN handover indicator.

In some aspects, the techniques described herein relate to an apparatus, wherein the source PLMN is a home PLMN of a user associated with the user equipment, the target PLMN is a visited PLMN, and the one or more processors are configured to exchange by: sending, to the visited PLMN, a user equipment context request that indicates a handover event for the data session; and in responsive to sending, receiving, from the visited PLMN, a data session request that indicates a handover event for the data session.

In some aspects, the techniques described herein relate to an apparatus, wherein the target PLMN is a home PLMN of a user associated with the user equipment, the source PLMN is a visited PLMN, and the one or more processors are configured to exchange by: sending, to the home PLMN, a user equipment context request that identifies a handover event for the data session.

In some aspects, the techniques described herein relate to an apparatus, wherein: the source network functions include a source radio access network (RAN), a source session management function (SMF), and a source access and mobility management function (AMF).

In some aspects, the techniques described herein relate to non-transitory computer readable media encoded with instructions that, when executed by one or more processors, cause the one or more processors to perform: at source network functions of a source public land mobile network (PLMN) (source PLMN): executing an attach procedure by which user equipment attaches to the source PLMN and establishes a data session with a data network; upon detecting a roam of the user equipment from the source PLMN to a target PLMN, accessing an inter-PLMN handover indicator that indicates whether a seamless inter-PLMN handover is allowed or is not allowed for the data network; and selectively performing the seamless inter-PLMN handover of the data session from the source PLMN to the target PLMN as directed by the inter-PLMN handover indicator.

In some aspects, the techniques described herein relate to a non-transitory computer readable media, wherein the instructions to cause the one or more processors to perform selectively performing include instructions to cause the one or more processor to perform: when the inter-PLMN handover indicator indicates that the seamless inter-PLMN handover is allowed, performing the seamless inter-PLMN handover of the data session from the source PLMN to the target PLMN, such that handover continuity of the data session is maintained.

In some aspects, the techniques described herein relate to a non-transitory computer readable media, wherein the instructions to cause the one or more processors to perform selectively performing further include instructions to cause the one or more processor to perform: when the inter-PLMN handover indicator indicates that the seamless inter-PLMN handover is not allowed, not performing the seamless inter-PLMN handover of the data session from the source PLMN to the target PLMN, such that handover continuity of the data session is not maintained.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method comprising:
at source network functions of a source public land mobile network (PLMN) (source PLMN):
executing an attach procedure by which user equipment attaches to the source PLMN and establishes a data session with a data network;
upon detecting a roam of the user equipment from the source PLMN to a target PLMN, accessing an inter-PLMN handover indicator that indicates whether a seamless inter-PLMN handover is allowed or is not allowed for the data network; and
selectively performing the seamless inter-PLMN handover of the data session from the source PLMN to the target PLMN as directed by the inter-PLMN handover indicator.

2. The method of claim 1, wherein selectively performing includes:
when the inter-PLMN handover indicator indicates that the seamless inter-PLMN handover is allowed, performing the seamless inter-PLMN handover of the data session from the source PLMN to the target PLMN, such that handover continuity of the data session is maintained.

3. The method of claim 2, wherein selectively performing further includes:
when the inter-PLMN handover indicator indicates that the seamless inter-PLMN handover is not allowed, not performing the seamless inter-PLMN handover of the data session from the source PLMN to the target PLMN, such that handover continuity of the data session is not maintained.

4. The method of claim 1, wherein the inter-PLMN handover indicator is stored in a user subscription database that includes data network names mapped to inter-PLMN handover indicators that each indicates whether a seamless inter-PLMN handover is allowed or is not allowed, and the method further comprises:
upon executing the attach procedure, fetching the inter-PLMN handover indicator from the user subscription database based on a data network name of the data network obtained from the attach procedure, and storing the inter-PLMN handover indicator for later access,
wherein accessing includes accessing the inter-PLMN handover indicator as stored.

5. The method of claim 1, further comprising, at the source network functions of the source PLMN:
upon detecting the roam, exchanging inter-PLMN handover messages with target network functions of the target PLMN; and
triggering accessing the inter-PLMN handover indicator responsive to exchanging the inter-PLMN handover messages.

6. The method of claim 5, wherein the source PLMN is a home PLMN of a user associated with the user equipment, the target PLMN is a visited PLMN, and exchanging includes:
sending, to the visited PLMN, a user equipment context request that indicates a handover event for the data session; and
in responsive to sending, receiving, from the visited PLMN, a data session request that indicates a handover event for the data session.

7. The method of claim 5, wherein the target PLMN is a home PLMN of a user associated with the user equipment, the source PLMN is a visited PLMN, and exchanging includes:
sending, to the home PLMN, a user equipment context request that identifies a handover event for the data session.

8. The method of claim 1, wherein:
the source network functions include a source radio access network (RAN), a source session management function (SMF), and a source access and mobility management function (AMF).

9. The method of claim 1, wherein the source PLMN and the target PLMN are each a 5G network.

10. An apparatus comprising:
one or more network processor units to communicate over one or more networks; and
one or more processors coupled to the one or more network processor units and configured to implement source network functions of a source public land mobile network (PLMN) (source PLMN), wherein the one or more processors are configured to:
execute an attach procedure by which user equipment attaches to the source PLMN and establishes a data session with a data network;
upon detecting a roam of the user equipment from the source PLMN to a target PLMN, accessing an inter-PLMN handover indicator that indicates whether a seamless inter-PLMN handover is allowed or is not allowed for the data network; and
selectively perform the seamless inter-PLMN handover or not perform the seamless inter-PLMN handover of the data session from the source PLMN to the target PLMN as directed by the inter-PLMN handover indicator.

11. The apparatus of claim 10, wherein the one or more processors are configured to selectively perform by:
when the inter-PLMN handover indicator indicates that the seamless inter-PLMN handover is allowed, perform the seamless inter-PLMN handover of the data session from the source PLMN to the target PLMN, such that handover continuity of the data session is maintained.

12. The apparatus of claim 11, wherein the one or more processors are further configured to selectively perform by:
when the inter-PLMN handover indicator indicates that the seamless inter-PLMN handover is not allowed, not perform the seamless inter-PLMN handover of the data session from the source PLMN to the target PLMN, such that handover continuity of the data session is not maintained.

13. The apparatus of claim 10, wherein the inter-PLMN handover indicator is stored in a user subscription database that includes data network names mapped to inter-PLMN handover indicators that each indicates whether a seamless inter-PLMN handover is allowed or is not allowed, and the one or more processors are further configured to:
upon executing the attach procedure, fetch the inter-PLMN handover indicator from the user subscription database based on a data network name of the data network obtained from the attach procedure, and store the inter-PLMN handover indicator for later access,
wherein the one or more processors are configured to access by accessing the inter-PLMN handover indicator as stored.

14. The apparatus of claim 10, wherein the one or more processors are further configured to:
upon detecting the roam, exchange inter-PLMN handover messages with target network functions of the target PLMN, and which trigger access of the inter-PLMN handover indicator.

15. The apparatus of claim 14, wherein the source PLMN is a home PLMN of a user associated with the user equipment, the target PLMN is a visited PLMN, and the one or more processors are configured to exchange by:
sending, to the visited PLMN, a user equipment context request that indicates a handover event for the data session; and
in responsive to sending, receiving, from the visited PLMN, a data session request that indicates a handover event for the data session.

16. The apparatus of claim 14, wherein the target PLMN is a home PLMN of a user associated with the user equipment, the source PLMN is a visited PLMN, and the one or more processors are configured to exchange by:
sending, to the home PLMN, a user equipment context request that identifies a handover event for the data session.

17. The apparatus of claim 10, wherein:
the source network functions include a source radio access network (RAN), a source session management function (SMF), and a source access and mobility management function (AMF).

18. Non-transitory computer readable media encoded with instructions that, when executed by one or more processors, cause the one or more processors to perform:
at source network functions of a source public land mobile network (PLMN) (source PLMN):
executing an attach procedure by which user equipment attaches to the source PLMN and establishes a data session with a data network;
upon detecting a roam of the user equipment from the source PLMN to a target PLMN, accessing an inter-PLMN handover indicator that indicates whether a seamless inter-PLMN handover is allowed or is not allowed for the data network; and
selectively performing the seamless inter-PLMN handover of the data session from the source PLMN to the target PLMN as directed by the inter-PLMN handover indicator.

19. The non-transitory computer readable media of claim 18, wherein the instructions to cause the one or more processors to perform selectively performing include instructions to cause the one or more processors to perform:
when the inter-PLMN handover indicator indicates that the seamless inter-PLMN handover is allowed, performing the seamless inter-PLMN handover of the data session from the source PLMN to the target PLMN, such that handover continuity of the data session is maintained.

20. The non-transitory computer readable media of claim 19, wherein the instructions to cause the one or more processors to perform selectively performing further include instructions to cause the one or more processors to perform:
when the inter-PLMN handover indicator indicates that the seamless inter-PLMN handover is not allowed, not performing the seamless inter-PLMN handover of the data session from the source PLMN to the target PLMN, such that handover continuity of the data session is not maintained.
